(19) United States
(12) Patent Application Publication
(10) Pub. No.: US 2009/0083766 A1
(43) Pub. Date: Mar. 26, 2009

(54) SYSTEMS FOR PERFORMING BARE MACHINE COMPUTER APPLICATIONS

(75) Inventors: Ramesh K. Karne, Finksburg, MD (US); Alexander L. Wijesinha, York, PA (US); Gholam H. Khaksari, Baltimore, MD (US)

Correspondence Address: PEPPER HAMILTON LLP, ONE MELLON CENTER, 50TH FLOOR, 500 GRANT STREET, PITTSBURGH, PA, 15219, US

(73) Assignee: TOWSON UNIVERSITY, Towson, MD (US)

(21) Appl. No.: 12/023,628

(22) Filed: Jan. 31, 2008

Related U.S. Application Data
(60) Provisional application No. 60/975,262, filed on Sep. 26, 2007.

(51) Int. Cl. G06F 9/44; G06F 3/00; G06F 12/00

(52) U.S. Cl. 719/321; 710/13; 711/103; 711/E12.001

(57) ABSTRACT

Systems for performing bare machine computing are disclosed. A system may include a bare machine computing platform that includes a processor, one or more input/output devices, and a storage medium. The bare machine computing platform does not include an operating system. The system may further include a processor readable storage medium including one or more instructions for implementing an application object. The application object may contain data and one or more instructions for enabling an operating environment and executing an application within the operating environment.

### REFERENCE TO RELATED APPLICATION

This application claims priority to U.S. Provisional Application No. 60/975,262, entitled, “Apparatus for Bare Machine Computer Applications” and filed Sep. 26, 2007, which application is hereby incorporated by reference in its entirety.

Not Applicable

### BACKGROUND

Software applications are conventionally executed on a computer that utilizes an operating system (OS) within a computing environment, such as the one depicted in FIG. 1. As shown in FIG. 1, a user 105 may interface with a computer using user interface tools 110 (i.e., input/output devices). The user interface tools 110 may take many forms, such as text and/or graphic displays, navigation tools, including a mouse, a trackball and the like, Internet browsers, multi-media devices including speakers, microphones and the like, and numerous other devices. The user interface tools 110 may interact with one or more software applications 115 and one or more OS components 120. Exemplary software applications 115 may include desktop applications, such as word processors, image viewers, computer-aided design tools, games, programming language editors, database applications, networking applications, and a wide variety of other types of applications. The software applications 115 may also interface with the OS components 120. The OS components 120, such as the various Microsoft® OS products, Linux, MacOS® and the like, may interface with device drivers 125, the physical hardware 130 and the BIOS (Basic Input-Output System) 135 to control operation of the underlying system components. Likewise, the device drivers 125 may interface with the physical hardware 130 and the BIOS 135 to control particular hardware components, such as a mouse driver providing the computing system with information received from a mouse and a graphics card controlling information received from a processor for a display.

Traditionally, when a computing platform changes, a software application designed for the old computing platform would have to be ported to the new computing platform. For example, if a user switches the operating system on their computer from Microsoft Windows XP® to Linux, new software applications would have to be installed to replace the Windows XP®-based applications. The process of updating software applications to match the current operating system, hardware or the like has resulted in the waste of programs, programming and human effort over the last four decades or more. Moreover, hardware, software and technical skills have become obsolete as a result.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to an “application” is a reference to one or more applications and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a system for performing bare machine computing may include a bare machine computing platform and a processor readable storage medium. The bare machine computing platform may include a processor, one or more input/output devices, and a storage medium. The bare machine computing platform does not include an operating system. The processor readable storage medium may include one or more instructions for implementing an application object. The application object may contain data and one or more instructions for enabling an operating environment and executing an application within the operating environment.

In an embodiment, a processor-readable storage medium may include one or more instructions for implementing an application object. The application object may contain all software programs and data necessary to enable an operating environment and to execute an application within the operating environment.

### BRIEF DESCRIPTION OF THE DRAWINGS

Aspects, features, benefits and advantages of the present invention will he apparent with regard to the following description and accompanying drawings, of which:

FIG. 1 depicts a representation of the components of a conventional operating system-based computing environment.

FIG. 2 depicts a representation of the components of a bare machine computing environment according to an embodiment.

FIG. 3 depicts an exemplary process for switching from real mode to protected mode and vice versa according to an embodiment.

FIG. 4 depicts a block diagram of an exemplary network layering and protocol architecture according to an embodiment.

FIG. 5 depicts an exemplary TCB data structure according to an embodiment.

FIG. 6 depicts an exemplary data format for the Interrupt Descriptor Table, the Global Descriptor Table and the Task-State Segment according to an embodiment.

FIG. 7 depicts an exemplary block diagram for a task execution stack and idle tasks according to an embodiment.

FIG. 8 depicts an exemplary state diagram for a task execution process according to an embodiment.

FIG. 9a depicts an exemplary block diagram of a zero-copy buffering scheme for incoming voice packets according to an embodiment.

FIG. 9h depicts an exemplary block diagram of a zero-copy buffering scheme for outgoing voice packets according to an embodiment.

FIG. 10 depicts a flow diagram for a method of processing an incoming voice packet according to an embodiment.

FIG. 11 depicts a flow diagram for a method of processing an outgoing voice packet according to an embodiment.

FIG. 12 depicts an exemplary message passing scheme for establishing a connection between a caller and a recipient using a bare VoIP softphone according to an embodiment.

FIG. 13 depicts an exemplary method for securely exchanging AES keys in a bare computing environment according to an embodiment.

FIG. 14 depicts an exemplary method for securely transmitting audio data according to an embodiment.

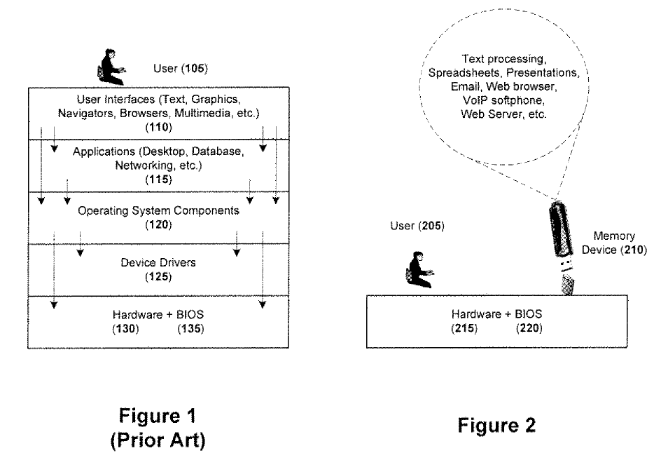

### DETAILED DESCRIPTION

The following terms shall have, for the purposes of this application, the respective meanings set forth below.

An “application object” is an application program containing all of the software and information necessary to enable one or more applications and the operating environment. In other words, an application object contains both its application program (or programs) and its necessary application operating environment. An application object is self-contained, self-managed and self-executed, which enables it to run on any hardware, provided it is compiled for the relevant hardware architecture.

Application objects self-manage the CPU, memory, interrupts and/or I/O for a bare computing platform. An application object may be self-executed. In other words, an application object may manage its loading, execution and termination phases. In an embodiment, a device, such as a flash drive, containing the application object may include a controller or process for managing the operations of the application object. It may also contain temporal information and security mechanisms. The application object interfaces that enable an application to run on a bare computing platform may be part of an application operating environment and/or implemented in hardware. The interfaces described herein are in hardware.

An application object may include, for example and without limitation, boot code, a loader protocol, one or more functions pertaining to each of one or more applications, data, networking protocols and the like. An exemplary application object may contain all software, data and the like necessary to perform, for example Voice over Internet Protocol (VoIP) functionality on a computing system that does not contain an operating system.

FIG. 2 depicts a representation of the components of a bare machine computing environment according to an embodiment. Decoupling the operating environment and bundling the necessary operating environment with a software application may significantly reduce the number of interfaces required to perform an operation. As such, it is significantly less likely that the computer system will become obsolete because the hardware is bare and the software is self-contained. As shown in FIG. 2, a user 205 may insert a portable memory device 210, such as a flash drive, CD, DVD, floppy disk or the like, containing an application object into a computing system comprising hardware 215 and BIOS 220. In an embodiment, the application object may include a VoIP softphone. Additional and/or alternate software applications may be included within the scope of this disclosure.

In an alternate embodiment, the application object may be stored in a memory resident on the computing system. In an alternate embodiment, the application object may be stored remotely and accessed via a communications network, such as the Internet, an intranet, and/or a wireless network.

The bare machine computing paradigm may be used for all types of applications, including applications operating on conventional personal computing, business computing, embedded and pervasive devices. As such, a bare machine computing platform (i.e., a bare machine) may provide direct interfaces to one or more application programs to a user. An application object used on a bare machine essentially operates as an end-user application. As such, only end-user applications may be required to be designed and programmed to the exclusion of operating system platforms and other associated software that are commonly required today.

Use of application objects may enable hardware 215 to become more stable because the hardware of a computing system is required to support both existing and newly created application objects. As a result, application programming interfaces (APIs) may be extended, rather than replaced. Because the performance and the cost of hardware are substantially the same in a variety of devices, it may be possible to share a common chip among a plurality of application domains. Moreover, a standard CPU architecture and a standard programming language may be used for pervasive devices. In sum, the use of application objects may result in a novel approach to computing based on application objects and more productive software engineering methodologies.

The apparatuses and storage media described herein provide for bare machine application objects. In particular, bare machine applications based on Intel IA32-compatible central processing units (CPUs) may be created. The bare machine may include, for example and without limitation, a CPU, a memory a keyboard, a display, an Ethernet card (either external or on-board), and one or more audio chips. In an embodiment, the bare machine does not require a hard drive.

In an embodiment, software may be resident on a permanent removable storage medium, such as a floppy disk, a CD, a DVD or a flash drive. The storage medium may contain, for example, the boot code and the application object. An application object may be a single application, such as a VoIP softphone, or a plurality of applications built into a single application object, such as a “communication explorer” including email, a VoIP softphone, an Internet browser and a personal Web server. Other applications may also or alternately be included in an application object within the scope of this disclosure.

An application object may be incorporated into a single executable file stored on the storage medium. As such, the application object, when executed, may be the only non-BIOS software program executed on the machine. As a result, the application object may directly access hardware interfaces that control the operation of the hardware 215. A user may possess the storage medium containing the application object and may customize the application and the storage medium for security and usage.

Conventionally, an application program does not manage any resources. Rather, the OS or kernel running on the hardware provides all resources and manages them. In bare machine computing, an application program may have sole control of resources and their management. For example, the Interrupt Descriptor Table (IDT), the Global Descriptor Table (GDT) and the Task-State Segment (TSS) entities of a convention 386-based computing system may be initialized and managed by an application object. Exemplary IDT and GDT entries are shown in Tables 1a and 1b. API calls may be used to enable the programmer of an application object to include software constructs in the application object to manage these facilities, which can be initialized to provide control over interrupt vectors and global memory.

TABLE 1a
Exemplary IDT Entries

| | | |
|---|---|---|
| Gate | <HTimerBegin, Puthex32I_Sel,,AT386TGate,> | ;hardware timer interrupt 08h |
| Gate | <, GetSecTSS,,ATTaskGate,> | ;read one vector at a time 0fah |
| Gate | <test2, EthernetReceive_Sel,,AT386IGate,> | ;Ethernet RCV Interrupt 77h |
| Gate | <,App1TSS_Sel,,ATTaskGate,> | ;Application 0feh |

TABLE 1b
Exemplary GDT Entries

| GDT | LABEL | BYTE |
|---|---|---|
| Puthex32I | Desc | <DemoCodeLen−1, DemoCodeSeg+RELOCATE1,, ATCE, D32,> |
| Puthex32I_Sel | = | Puthex32I−GDT |
| GetSecTSS | Desc | <GetSecTSSLen−1, GetSecTSSSeg+Relocate1,, AT386TSS,,> |
| GetSecTSS_Sel | = | GetSecTSS−GDT ;AT386TSS = 89h |
| EtherDesc | Desc | <EtherRcvCodeLen−1, EtherRcv+RELOCATE1,, ATCE, D32,> |
| EtherRcv_Sel | = | EtherDesc−GDT |
| App1TSS | Desc | <App1TSSLen−1, App1TSSSeg+RELOCATE1,, AT386TSS,,> |
| App1TSS_Sel | = | App1TSS−GDT ;AT386TSS =89h Application |
| GDTLen | = | $−GDT |

In addition, bare machine computing using application objects may enable controlled switching between real mode and protected mode within a computing system when the application object is being executed. On a conventional computing platform, the BIOS operates in real mode and the operating system and applications operate in protected mode. Transferring a software application to real mode would likely cause errors in a conventional system because memory operations performed by a software application could access memory locations assigned to, for example, a hardware device. For example, such memory accesses could disable the operation of the hardware device (i.e., a keyboard, a mouse, etc.) because the programmer of a conventional software application lacks knowledge of the physical memory locations to which hardware devices are mapped. However, in a bare machine computing environment, the application object has knowledge of the precise location of every mapped hardware device and other memory location. Accordingly, an application object may safely access real mode.

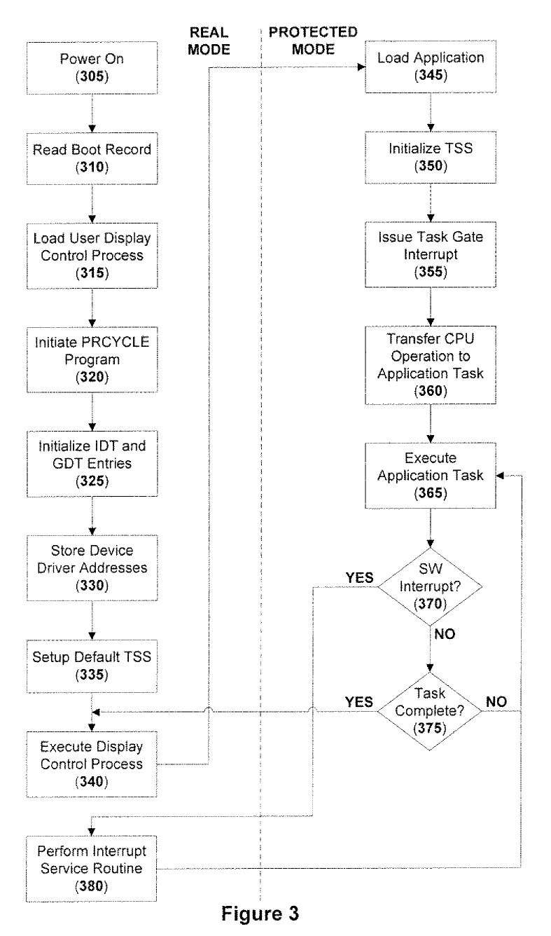

FIG. 3 depicts a flow diagram of an exemplary process for switching from real mode to protected mode and vice versa according to an embodiment. As shown in FIG. 3, power may be turned on 305 and the boot record may be read 310 from a floppy or USB flash drive in real mode. Using the loader stored on the storage medium, a user display control process may be loaded 315, for example and without limitation, at memory location 0x00000800. A PRCYCLE program may be initiated 320, and IDT and GDT table entries may be initialized 325. Device driver addresses may be read from the devices and stored 330 into shared memory, for example and without limitation, starting at memory location 0x00008600. A default TSS may be setup 335 including dummy data. A user display control process may then be executed 340, which awaits a user action, such as selection of an application.

When an application is selected, the loading process may then switch to protected mode to load 345 the application, for example and without limitation, at memory location 0x00110000. The TSS may be initialized 350 with appropriate values for the Instruction Pointer (EIP), Base Pointer (EBP), Stack Pointer (ESP) and Flags (EFlag). A Task Gate Interrupt (such as interrupt 0feh in an IA32-based system) may be issued 355, and the CPU may switch 360 from the initial task to the application task. The application task may then be executed 365. If the application task issues 370 a software interrupt for real mode service, an interrupt service routine may be executed 380 in real mode. A determination may be made 375 as to whether the application task has completed all operations. If so, the application task may terminate and return to 340 to await further action. Otherwise, the application task may continue to execute 365 operations.

In general, real mode may be used to provide access to BIOS interrupts and hardware interrupts, such as keyboard, timer, floppy and task switching interface interrupts, as well as boot operations; application programs, on the other hand, may be executed in protected mode. Hardware devices and application programs may communicate using shared memory locations. Exemplary subroutine calls for accessing shared memory locations are show in Table 2.

TABLE 2
C++/C Shared Memory Calls

```
//C++ API
//--------------------------------------------------------------------
long AOAProtected::AOAgetSharedMem(int index){
        return CgetSharedMem32 (index);
}
//--------------------------------------------------------------------
void AOAProtected::AOAsetSharedMem(int index, long val){
        CsetSharedMem32 (index, val);
}
//--------------------------------------------------------------------
//C Calls
extern long getsharedmemasm32(int);
long CgetSharedMem32(int index)
{
        return getsharedmemasm32(index);
}
//---------------------------------------------------------------------
extern void setsharedmemasm32(int, long);
void CsetSharedMem32(int index, long val)
{
        setsharedmemasm32(index, val);
}
```

Hardware devices typically have device drivers and an API that may be used by an application programmer. A device driver address may be assigned to each device in a computer's memory. For example, a device driver address may be assigned to a hardware device during initialization and stored in shared memory. Application programs may then read the device driver address during execution in protected mode. Tables 3a-3d show exemplary Ethernet, Audio, Keyboard and Display device driver APIs that can be invoked from an application program. As shown in Tables 3a-3d, all hardware and device driver interfaces may be made available to the application programs in a bare machine computing environment.

TABLE 3a
Ethernet Interface

//Ethernet Interface (can be called from any place in the application program)
RXSize = EO.ReadData(&Data, &PacketType);
//Ethernet object implementation
int EtherObj::ReadData(char** Data, int* Type)
{
p1 = (long *) (UpListPointer + ReceiveOutPtr * 32 + 4 − ADDR_OFFSET); //status
p3 = (long *) (UpListPointer + ReceiveOutPtr * 32 + 8 − ADDR_OFFSET); //address
*Data = (char*) s1 − ADDR_OFFSET;
//buffer is pointing to the same memory location as pointed by download pointer descriptor
//ADDR_OFFSET is 0x00110000
//system will add ADDR_OFFSET (0x00110000) from the selector or base address
pktlen = *p1; //get the status into pktlen variable
pktlen = pktlen & 0x00001FFF //extract packet length
}

TABLE 3b
Audio Interface

void AudioObj::init(int p1, int p2, int p3, int p4)
void AudioObj::createSpkrBDL(int baseAddress, int bufferPointer)
void AudioObj::createMicBDL(int baseAddress, int bufferPointer)
void AudioObj::enableVariableRateAudio( )
void AudioObj::setSampleRate(short val)
void AudioObj::setSpkrBDLData(long *lsrc, int num, int noOfBytes)
void AudioObj::getMicBDLData(int num, long *ldest, int noOfBytes)
void AudioObj::setZeroSpkrBDLData(int num, int noOfBytes)
void AudioObj::setZeroMicBDLData(int num, int noOfBytes)
int AudioObj::getSpkrCIV( )
int AudioObj::getMicCIV( )
int AudioObj::getSpkrLVI( )
void AudioObj::setSpkrLVI(int value)
int AudioObj::getMicLVI( )
void AudioObj::setMicLVI(int value)

TABLE 3c
Keyboard Interface

| //C++API - Keyboard Interface | |
|---|---|
| char AOAProtected::AOAgetCharacter( ) | |
| { | |
| int cursorp; | //cursor position |
| char c; | //character to be read |

| cursorp = AOAgetCursor( ); | //get cursor position |
|---|---|
| c = CgetChar32(cursorp); | //call get character |
| AOAprintCharacter(c, cursorp*2); | //echo the character |
| cursorp = cursorp + 1; //next position | |
| AOAsetCursor(cursorp); | //set up for next position |
| return c; | //return the character |
| } | |
| //C Call | |
| extern char getcharasm32(int); | |
| char CgetChar32(int pos) | |
| { | |
| return getcharasm32(pos); | |
| } | |

TABLE 3d
Display Interface

```
//C++API - Display Interface
char AOAProtected::AOAprintCharacter(char value, int pos)
{
  int retcode;
    if (pos < 0 || pos >= 4000)
        return −1;
    retcode = CprintChar32(value, pos);
    return retcode;
}
//C Call
int CprintChar32(char value, int start)
{
    pritncharasm32(value, start);
    return 0;
}
//ASM Call
printcharasm32 PROC C public uses ebx, value: byte, pos: dword
    mov ax, Video_sel_Loc
    mov es, ax
    mov al, value
    mov ah, 7
    mov WORD PTR es:[ebx], ax
    ret
printcharasm32 ENDP
```

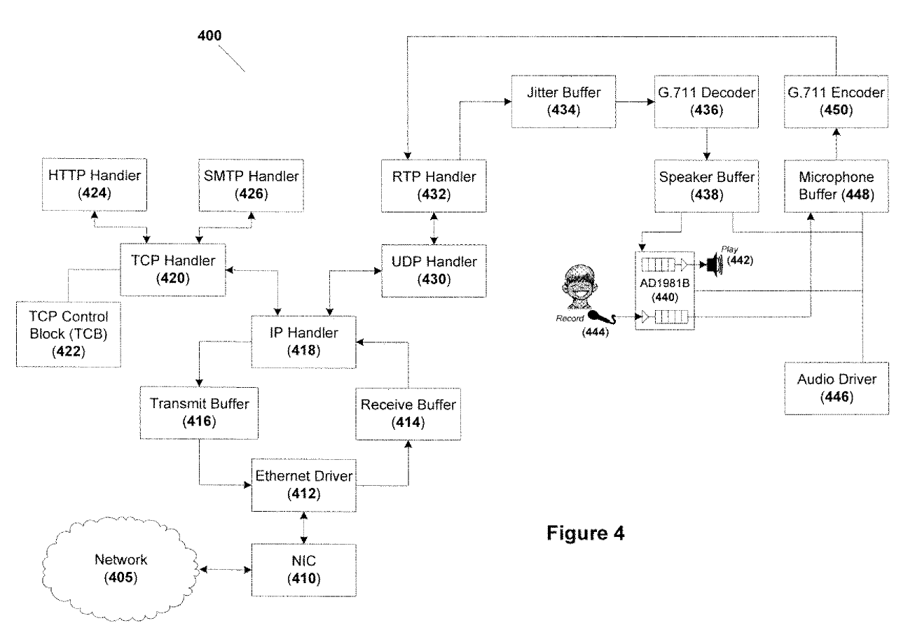

FIG. 4 depicts a block diagram of an exemplary network layering and protocol architecture according to an embodiment. The network layering and protocol architecture 400 may be utilized by any bare machine application object that requires interfacing with a network. Alternate architectures may be utilized that, for example, interface with input/output devices, such as a keyboard, a mouse, a display or the like. In an embodiment, one or more of such alternate architectures may be joined with the network layering and protocol architecture 400 in a single application object.

As shown in FIG. 4, the architecture 400 may be connected to a network 405, such as the Internet, an intranet, a wireless and/or wired network, or the like. The architecture may include, for example and without limitation, one or more of a network interface card (NIC) 410, such as an Ethernet card with an Ethernet driver 412; a receive buffer 414; a transmit buffer 416; an Internet Protocol (IP) handler 418; a Transmission Control Protocol (TCP) handler 420 with an associated TCP Control Block (TCB) 422; a Hypertext Transfer Protocol (HTTP) handler 424; a Simple Mail Transfer Protocol (SMTP) handler 426; a User Datagram Protocol (UDP) handler 430; a Real-time Transport Protocol (RTP) handler 432; a jitter buffer 434; a decoder 436, such as a G.711 decoder; a speaker buffer 438; an audio compressor/decompressor (CODEC) 440, such as the AD1981B CODEC made by Analog Devices, Inc. of Norwood, Mass.; a speaker 442; a microphone 444; an audio driver 446; a microphone buffer 448; and an encoder 450, such as a G.711 encoder. In an embodiment, less than all of the above-listed elements may be accessed during transmission or reception of a single set of data. Rather, data may be transmitted or received by particular elements based on the application to which the data corresponds.

For example, a VoIP softphone application may receive information from a user via the microphone 444 and compress the information using the audio CODEC 440. The audio driver 446 may store the compressed information in the microphone buffer 448. Data representing a particular period may be removed from the microphone buffer 448, encoded using the encoder 450 and passed to the RTP handler 432. The RTP handler 432 may prepend an RTP header and forward the RTP data to the UDP handler 430. The UDP handler 430 may prepend a UDP header and forward the UDP data to the IP handler 418. The IP handler 418 may prepend an IP header and store the IP data in a transmit buffer 416. The Ethernet driver 412 may remove data from the transmit buffer 416 and transmit the data from the NIC 410 to the network 405.

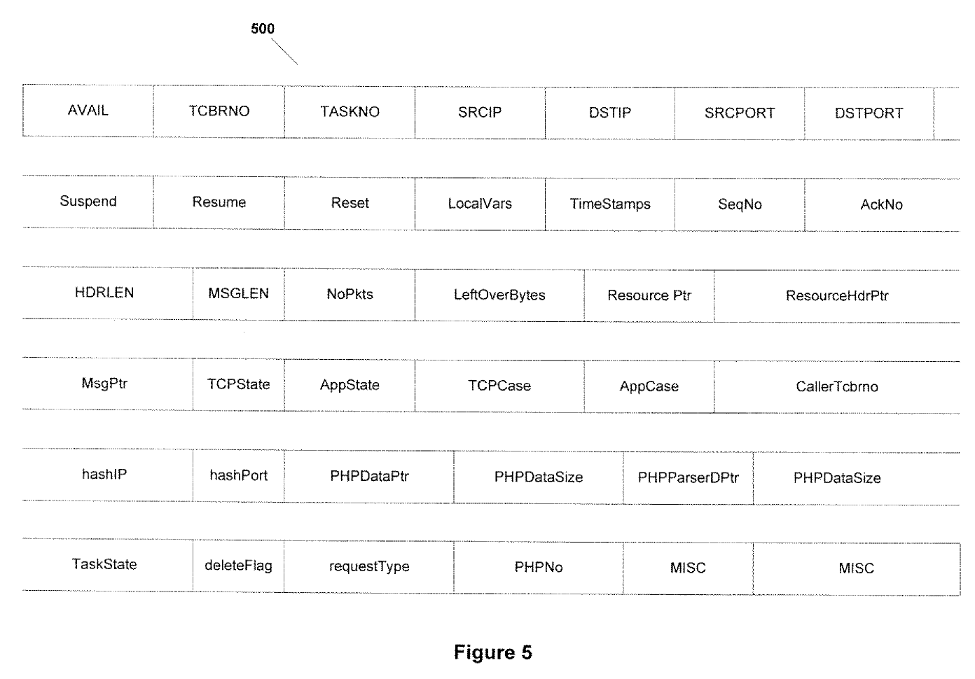

Conversely, a VoIP softphone application may receive data from a third party over the network 405 at the NIC 410. The driver 412 may store the information in the receive buffer 414. The IP handler 418, UDP handler 430 and RTP handler 432 may remove the corresponding headers from the received data. The RTP handler 432 may store the raw data in the jitter buffer 434. The decoder 436 retrieves the data from the jitter buffer 434, decodes it and stores it in the speaker buffer 438. The audio CODEC 440 retrieves the data from the speaker buffer 438, decodes the data, and plays it via the speaker 442. Similar paths may be utilized for an application including HTTP functionality (via the TCP handler 420 and HTTP handler 424) and/or SMTP functionality (via the TCP handler and SMTP handler 426). The TCB 422 may store state information pertaining to the TCP handler 420, which is discussed further below in reference to FIG. 5.

In an embodiment, the network layering and protocol architecture 400 of FIG. 4 may be contained with a single application object that performs VoIP management functionality as well as functionality of other applications. Alternate architectures, including less than all of the functionality contained in the network layering and protocol architecture 400 may be implemented within the scope of this disclosure.

It is noted that the network layering and protocol architecture 400 does not include sockets or process facilities for a networking subsystem as in a conventional operating system-based system. For a given application object and a set of applications, the network architecture and protocols may be tailored to best suit the need of the applications. No form of strict layering exists in the system although each network protocol may have a unique API that may be called directly from an application program.

Table 4 shows exemplary interfaces that may be independently contained within an application. In an embodiment, a programmer may use such interfaces to format and send a packet or receive and process a packet without breaking a single thread of execution in the application.

TABLE 4
Exemplary Network Architecture Direct Interfaces

```
int TCPObj::SendN(int TCBRecordNum, int currenttask);
int TCPHandler(char* TCPPack, int size, char* SourceIP, char* TargetIP, int Protocol,
        char *macaddr, long timer, int currenttask);
int TCPObj::FormatTCPPacket(char *TCPPack, char *destIP, char *destPort, char *sourcePort,
    char Flags, unsigned short Window, unsigned long seqnum, unsigned long acknum,
    char *data, int datasize, int rIndex, int currenttask);
int IPObj::sendData(char* data, int len, char DestIP[4], char DestMAC[6], int protocol,
          int currenttask);
int IPObj::IPHandler(char* IPPack, int size, char *macaddr, long timer, int currenttask);
int IPObj::FormatIPPacket(char* data, int len, char DestIP[4], char DestMAC[6], int protocol,
              int currenttask);
int RTPObj::RTPSendData(int currenttask, char *cptr1, long InPtr);
int RTPObj::Format RTPPacket(char *send_buffer, int currenttask);
int RTPObj::RTPHandler(char *tIP, unsigned short tPort, char *Packet, int PacketSize,
              int currenttask);
int EtherObj::ReadData(char** Data, int* Type, char *ipaddr, char *macaddr);
int EtherObj::FormatRTP Packet(char* pack, int pack_Size, int protocol, char* Target_HAdd,
                long InPtr, int sendtype, int currenttask);
int EtherObj::IPInsertPkt(char* pack, int pack_Size, int protocol, char* Target_HAdd,
            int currenttask);
int G711Codec::Encode(void *input, int inputSizeBytes, void *output, int *outputSizeBytes,
            int mono_or_stereo);
int G711Codec::Decode(void *input, int inputSizeBytes, void *output, int *outputSizeBytes,
            int mono_or_stereo);
```

Building network software entities may be difficult or impossible using OS-based systems. However, bare machine computing may enable software network entities to be constructed. For example, when a packet pertaining to information to be displayed on a browser is received from the NIC, the thread of execution proceeds through the Ethernet driver 412, IP handler 418, TCP handler 420 and HTTP handler 424 until the message is processed. Once the message is processed, the application object may return control to the main task using an AOAsuspend( ) call. Similarly, when a packet is ready to be sent, the packet may be transmitted through the HTTP handler 424, the TCP handler 420, the IP handler 418 and the Ethernet driver 412 as a single thread of execution until the packet is placed in an output buffer on the NIC. Buffer contents may be stored until the thread of execution is complete. As such, zero-copy buffering may be performed when processing network packets on a bare machine computing platform.

FIG. 5 depicts an exemplary TCB data structure according to an embodiment. As shown in FIG. 5, the exemplary TCB data structure 500 includes local variables, TCP state and control flags that are required to process a TCP message. Each request may have a single entry 500 in the TCB, which may be stored until the request is complete. The entry 500 may provide complete state and execution control for a given request. As such, the code may be re-entrant for other requests.

A self-contained TCB data structure 500 may be difficult to achieve in an OS-based system due to virtual memory, paging, system calls user mode and privileged mode switching. In contrast, implementing such a structure in an application object may be relatively easy because the programmer, via the application software, may retain control over all functionality of the bare machine.

A TCB entry 500 may provide control for state and execution of a complete request. As such, a TCB entry 500 may be used to perform load balancing in server clusters. Alternatively, a TCB entry 500 may be used to dynamically enable server migration (i.e., relocating a server and its present execution state instantaneously) to a remote location.

The computing platform described herein differs from software implemented on an embedded system because such software is designed to perform a single application (i.e., to operate the embedded application in concert with the system with which it is implemented). Moreover, embedded systems run on an operating system and do not provide open interfaces to run applications on bare hardware devices. For example, in an embedded system, such as a cell phone, no other applications can directly run on the hardware because there are no external interfaces to interact with the cell phone. In contrast, application objects may be modularly adapted or replaced with new application objects in a manner similar to general purpose computing applications.

Table 5 shows a C++ class member function that may be defined as a task and a code for the task. The pointer to the member function may be stored in an array. The address may be used to create a task and its related TSS. As such, multitasking may be performed in a bare machine because direct interfaces are provided to task management within application programs.

TABLE 5
C++ Class Member Function Enabling Multitasking

long *getFunctionPtr(pmfd abc2)
{
//this approach uses xyz as a stack pointer to locate where the
/address of the function is stored
AOAProtected io;
long v2;
long *ab1;
long *xyz;

| | |
|---|---|
| pmfd abc1; | //instance of a member ptr |
| apptask first; | //instance of a class |
| xyz = (long *)&first; | |
| abc1 = abc2; | //initialize the ptr with a function |

xyz−−;
ab1 = (long *)*xyz;
return (long*)ab1;
}
Function_Ptr_X = &apptask::AudioTask;
//initialize the ptr with a function AudioTask
Function_Address_arry[10] = (long) getFunctionPtr(Function_Ptr_X);
Task_ID-first.createTask((long)Function_Address_Array[10], 0);
io.AOenableIRQCntlr(1, 0xfe); //enable hardware timer IRQ0 INT08h
task.AOArunTask(0);

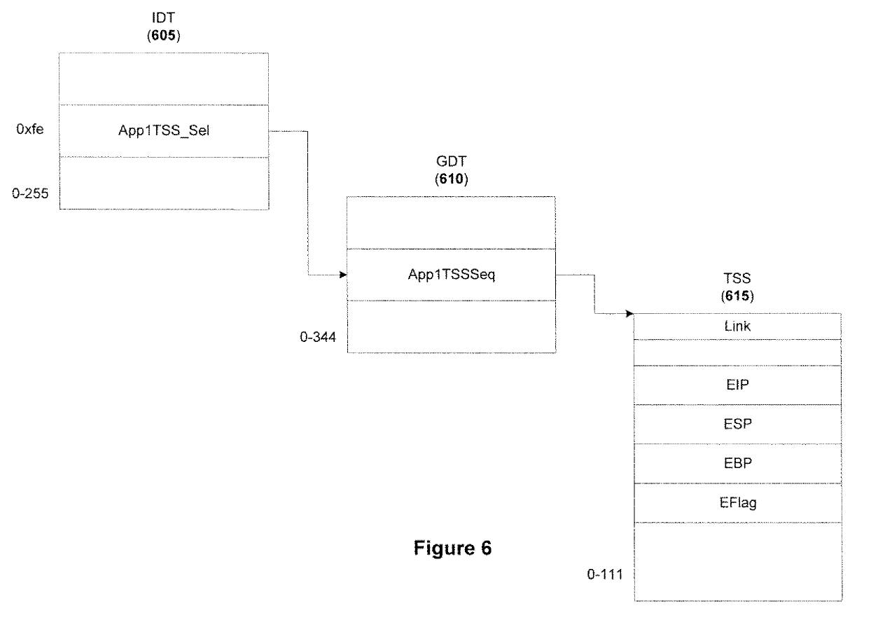

FIG. 6 depicts an exemplary data format for the Interrupt Descriptor Table, the Global Descriptor Table and the Task-State Segment according to an embodiment. As shown in FIG. 6, a single GDT entry 610 may be used for a plurality of tasks. In such an embodiment, the GDT entry may be modified to point to a different TSS, such as 615, for each task. A single IDT entry 605 that points to the GDT entry 610 may also be used to switch between tasks.

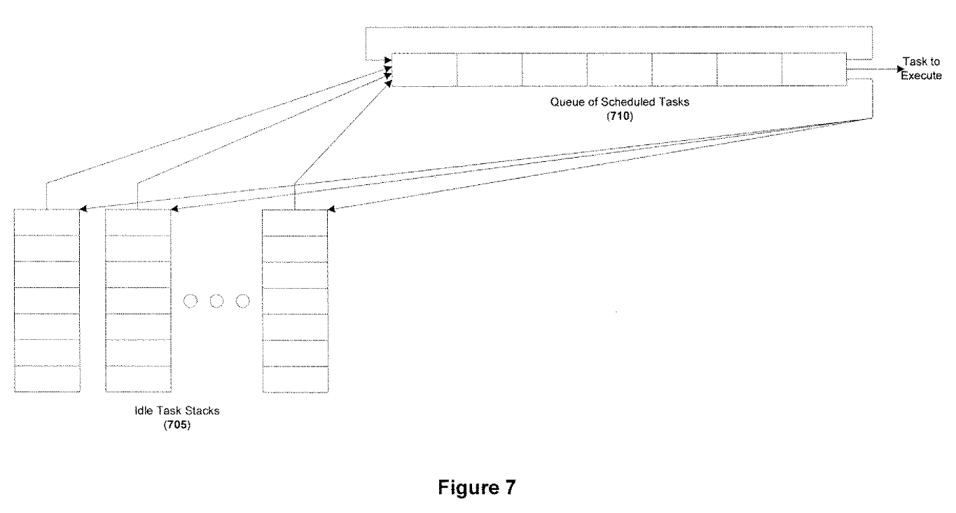

FIG. 7 depicts an exemplary block diagram for a task execution stack and idle tasks according to an embodiment. As shown in FIG. 7, an idle task stack 705 may include one or more tasks. An idle task may be scheduled for execution by adding the task to a queue of scheduled tasks 710 when the task has one or more operations to perform. In an embodiment, the scheduled tasks queue 710 may be a first in first out (FIFO) queue. After the one or more operations for the task have been executed, the task may be returned to the idle task stack 705.

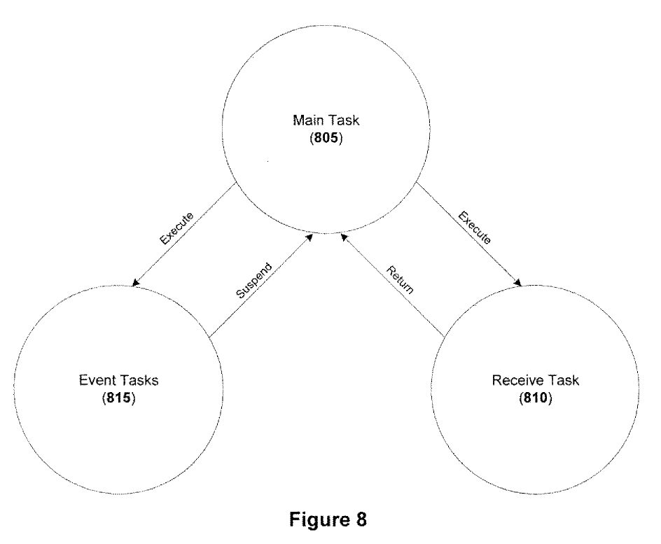

FIG. 8 depicts an exemplary state diagram for a task execution process according to an embodiment. As shown in FIG. 8, three types of tasks may be utilized by a bare machine computing system: a main task 805 may be used to execute an application; a receive task 810 may be used to receive data from a communication port, such as on an Ethernet card; and an event task 815 may be used to perform, for example, an audio, HTTP, display or other operation. For an event task 815, the relevant task may be taken from the idle task stack 705 and inserted into the scheduled task queue 710. In an embodiment, receive tasks 810 may not be added to the scheduled tasks queue 710. If a receive task 810 is not pending, an event task 815 may be selected from the scheduled tasks queue 710 for execution. If both a receive task 810 and one or more event tasks 815 are pending simultaneously, the main task 805 may determine whether to next process the receive task or the next event task in the scheduled tasks queue 710.

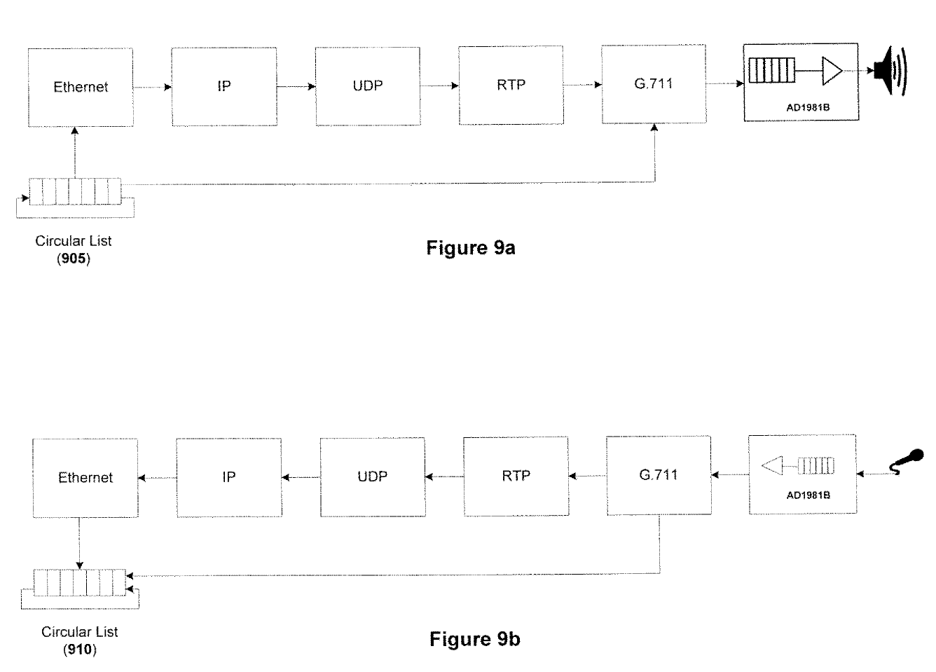

For a bare VoIP softphone application object, a voice packet may be received and stored into, for example, an Ethernet buffer. The Ethernet buffer may store the voice packet until the receive task 810 is selected to process it. In an embodiment, device drivers for the Ethernet card and chip may receive incoming voice packets and store them in a circular list 905, such as is shown in FIG. 9a. Similarly, outgoing voice packets may be stored in a circular list 910 by the application, such as is shown in FIG. 9b. The circular lists 905, 910 may be located in, for example, user address space. In a bare computing environment, user space and system space may be co-located because the application object programmer controls the memory map for the VoIP softphone and/or other applications.

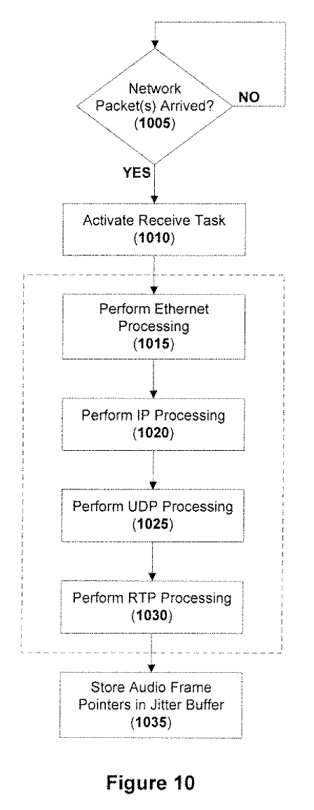

The main task 805 may check 1005 for the arrival of network packets in the receive circular list 905. The main task 805 may activate 1010 the receive task 810 for processing these packets. The receive task 810 may perform the Ethernet 1015, IP 1020, UDP 1025 and RTP 1030 processing for an incoming packet and store 1035 audio frame pointers (for the payload and RTP headers) in the jitter buffer in a single thread of execution, as shown in FIG. 10. An audio task 815 may request a frame from the jitter buffer, perform the G.711 decoding and write the decoded frame to a speaker circular play out buffer.

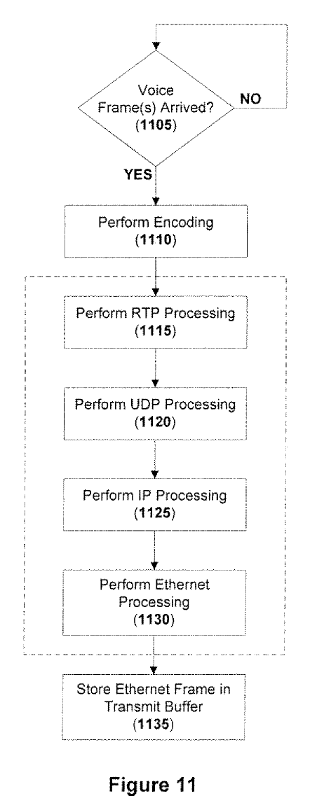

Similarly, the main task may check 1105 for voice frames in a microphone recording buffer and execute an audio task 815 to process these frames. The audio task 815 may perform the G.711 encoding 1110, and process the encoded frame using RTP 1115, UDP 1120, IP 1125 and Ethernet 1130 processing modules, as shown in FIG. 11. The audio frame 815 may then store 1135 the outgoing Ethernet frame to the send circular buffer 910 for transmission on the network in a single thread of execution.

In an embodiment, the implementation of network protocols such as RTP, UDP and IP may be integrated with Ethernet processing, as shown in Table 6 below. Strict layering rules may not be observed in a bare machine computing environment in order to achieve optimal performance. For example, all protocol processing 1115-1130 for sending an outgoing packet may be performed in a single step.

TABLE 6
Network Protocol Processing Operations

```
retcode = rp.Play(0);
    retcode = audio.getSpkrLVI( );
    speaker_read_ptr = audio.getSpkrCIV( );
    retcode = audio.getSpkrLVI( );
    retcode = audio.getSpkrPICB( );
    pstatus = jitter.Remove(&ln_v, &ln_p, &ln_x, &ln_cc, &ln_m, &ln_pt, &ln_sn, &ln_ts,
                &ln_ssrc, &ln_Payload_size, &ln_Payload_Ptr);
    pstatus = G711Codec.SetULaw( );
    pstatus = G711Codec.Decode((void*)cptr1, BUFFER_SIZE/2, (void*)cptr2, &ret_size,
                    1);
    pstatus = G711Codec.SetULaw( );
    pstatus = G711Codec.Decode((void*)cptr1, BUFFER_SIZE/2, (void*)cptr2, &ret_size,
                    1);
    audio.setSpkrLVI(0);
Record_Count = rp.GetMicCount(0);
    mic_write_ptr = audio.getMicCIV( );
    retcode = audio.getMicLVI( );
    retcode = audio.getMicPICB( );
    audio.setMicLVI( );
retcode = rp.Record(v1, 0); //Send packet
    G711Codec.SetULaw( );
    G711Codec.Encode(cptr1, BUFFER_SIZE, mic_buffer+mic_buffer_index, &ret_size, 0);
    rstatus = RTPObj::RTPSendData(v1, send_buffer, InPtr);
```

In an embodiment, bare VoIP softphone architecture may use the zero-copy buffering scheme described above in which incoming packets are stored in the receive upload pointer descriptor (UPD) buffer. The same pointer may be used until each packet has been uploaded. Likewise, zero copy buffering may be performed by using a pointer for the audio driver and the send download pointer descriptor (DPD) buffer. Embodiments using zero-copy buffering for uploading and downloading data are shown in FIGS. 9a and 9b.

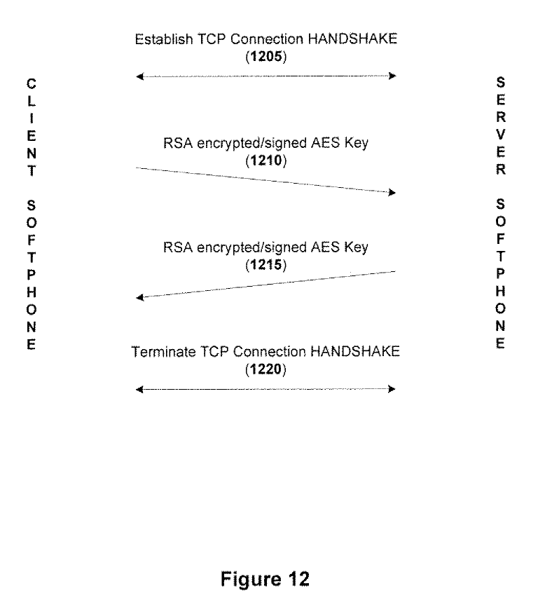

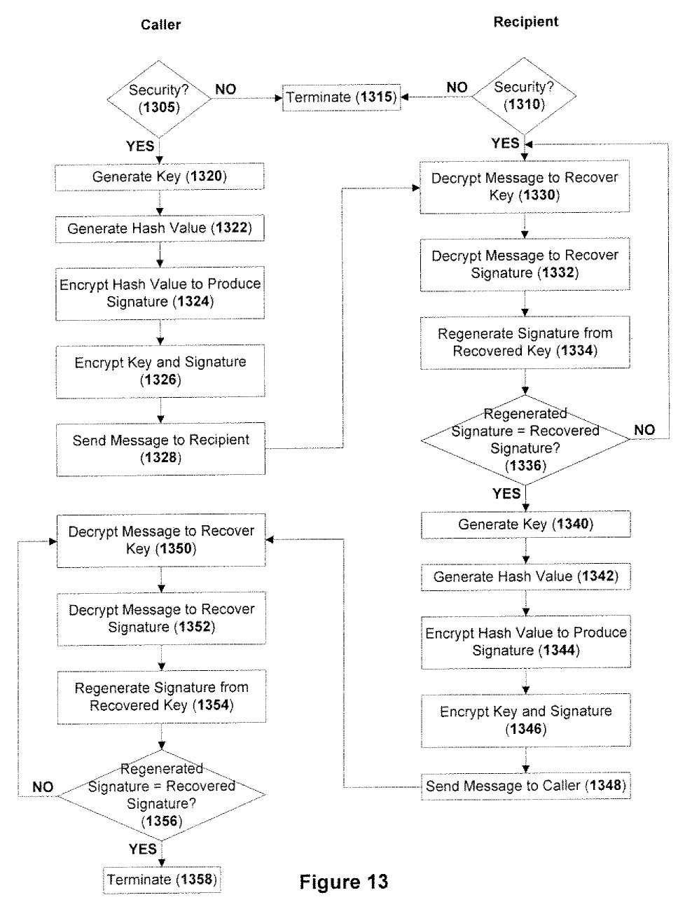

FIG. 12 depicts an exemplary message passing scheme for establishing a connection between a caller and a recipient using a bare VoIP softphone according to an embodiment. FIG. 13 depicts exemplary handshake steps for secure exchange of AES keys in a bare computing environment according to an embodiment. As shown in FIGS. 12 and 13, when a call using a bare VoIP softphone is made, a TCP connection may be established 1205 with the caller as the client and the recipient as the server. If security is not used by either the caller 1305 or the recipient 1310, the process may terminate 1315. The caller may generate for example and without limitation, an Advanced Encryption Standard (AES) key 1320 and its Secure Hashing Algorithm (SHA-1) hash value 1322. The hash value 1322 may be encrypted with, for example and without limitation, the caller's private RSA key to produce a signature 1324. The AES key and its signature may then be encrypted 1326 with, for example and without limitation, the recipient's public RSA key. A message 1328 including the encrypted AES key and the encrypted signature may then be sent 1210 to the recipient.

The recipient may decrypt the message using the recipient's private RSA key, which may be stored in encrypted form as described above, to recover the AES key 1330 and the signature 1332. The recipient may then decrypt the signature using the public RSA key of the caller. The signature may be verified by determining the SHA-1 hash 1334 of the AES key and comparing 1336 it to the decrypted signature. Assuming a match occurs between the computed signature and the decrypted signature, the recipient may respond by repeating each of the above steps taken by the caller after first generating 1340 a new AES key for use in the opposite direction 1342-1348. The recipient may then send 1215 a message 1350 including the encrypted AES key and the encrypted signature to the caller. If desired, the same AES key may be used in both directions.

The caller may then process the received message in the same manner as the recipient 1350-1358. The TCP connection may be closed 1220 upon completion of these operations.

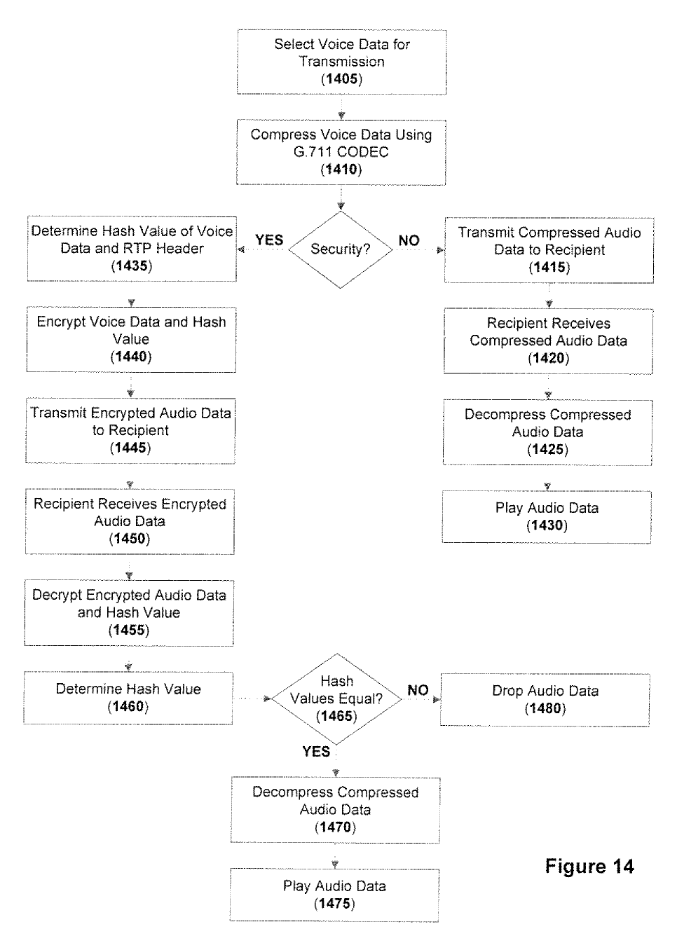

Assuming that the handshake is successful, each of the caller and recipient may have the AES key generated by the other side. As such, the caller and recipient may be able to send and receive encrypted authenticated voice messages, such as according to the embodiment depicted in FIG. 14.

As shown in FIG. 14, audio data may be selected 1405 for insertion into a packet. For example and without limitation, the audio data may be recorded using a microphone and compressed 1410 using a G.711 CODEC.

If security is not used, the compressed audio data may be transmitted 1415 to the recipient. The recipient may receive 1420 the compressed audio data, decompress 1425 the audio data, and play 1430 the audio data.

If security is required, the caller may determine 1435 an SHA-1 hash value of the audio data and RTP header. The audio data and its hash value may each be encrypted 1440 using, for example and without limitation, the caller's AES key. The inclusion of an encrypted hash value may provide data integrity and enable verification of the caller's identity. The inclusion of the RTP header in the hash value may ensure protection against replay because of a timestamp in the header. This is particularly the case where clocks synchronized using the Network Time Protocol (NTP) are used. In an alternate embodiment, replay protection may be provided when the recipient and caller use two bare softphones by including a nonce in the RTP header. The encrypted audio data and hash value may then be transmitted 1445 to the recipient.

The recipient may receive 1450 and decrypt 1455 the encrypted audio data and hash value using the AES key transferred during the handshake. The recipient may then independently determine 1460 the hash value and compare 1465 the determined hash value with the decrypted hash value in order to verify the received data. If the two hash values match, the audio data may be decompressed 1470 and played 1475. Otherwise, the audio data may be dropped 1480. Because the AES key was exchanged securely, only legitimate parties may be also to play 1475 the decrypted audio message. As such, the integrity of the data and the caller's identity are guaranteed.

In an embodiment, updated AES session keys may be generated. For example and without limitation, a new AES session key may be generated when a new call is initiated. In an embodiment, a new AES session key may be produced after a known or approximate time interval during a call of extended duration in order to heighten security between bare softphones.

When execution of an application object completes, control may be returned to the main menu or the display. A user may then exit the process, make another call using the VoIP application object, or execute a different application.

In an embodiment, a USB flash drive may be used to execute such an application on bare machines connected to a network at any location. These applications may be referred to as “carry on” applications.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A system for performing bare machine computing, comprising:
a bare machine computing platform, comprising:
a processor,
one or more input/output devices, and
a storage medium,
wherein the bare machine computing platform does not include an operating system; and
a processor readable storage medium including one or more instructions for implementing an application object, wherein the application object contains data and one or more instructions for enabling an operating environment and executing an application within the operating environment.

2. The system of claim 1 wherein the processor readable storage medium comprises a portable memory device.

3. The system of claim 1 wherein the processor readable storage medium comprises one of the following:
a flash drive;
a compact disc (CD);
a digital video disc (DVD); and
a floppy disk.

4. The system of claim 1 wherein the processor readable storage medium is remote from the processor.

5. The system of claim 1 wherein the one or more input/output devices comprise a microphone and a speaker, and wherein the application object comprises a VoIP softphone application.

6. The system of claim 1 wherein the bare machine computing platform is configured to initiate execution of the application when the processor-readable storage medium is in operable communication with the processor.

7. The system of claim 1 wherein the processor-readable storage medium further includes a controller configured to execute the application when the processor-readable storage medium is in operable communication with the bare machine computing platform.

8. The system of claim 1 wherein the application object further includes one or more instructions for directly initializing and managing an interrupt descriptor table and a global descriptor table.

9. The system of claim 1 wherein the application object further includes one or more instructions for switching between a protected mode and a real mode, wherein the protected mode permits execution of the operation, wherein the real mode permits handling of an interrupt and direct access of a device driver for at least one input/output device.

10. The system of claim 9 wherein the application object further includes one or more instructions for accessing the device driver for the input/output device.

11. The system of claim 1 wherein the one or more input/output devices comprise a network interface card, and wherein the application object further includes one or more instructions for implementing one or more network protocols required by the network interface card.

12. The system of claim 11 wherein the one or more network protocols comprise one or more of Internet Protocol, Transmission Control Protocol, Hypertext Transfer Protocol, Simple Mail Transfer Protocol, User Datagram Protocol, and Real-time Transport Protocol.

13. A processor-readable storage medium including one or more instructions for implementing an application object, wherein the application object contains all software programs and data necessary to enable an operating environment and to execute an application within the operating environment.

14. The storage medium of claim 13 wherein the application object comprises data and one or more instructions for performing each of a boot operation, an application loading operation, and the application.

15. The storage medium of claim 14 wherein the application object further comprises data and one or more instructions for performing network interface operations.

16. The storage medium of claim 13 wherein the application comprises a VoIP softphone management application.

17. The storage medium of claim 13 wherein the processor-readable storage medium is configured to communicate with a processor, wherein the processor is configured to execute the application when in operable communication with the processor-readable storage medium.
